(19) United States
(12) Patent Application Publication
(10) Pub. No.: US 2014/0007102 A1
(43) Pub. Date: Jan. 2, 2014

(54) AUTOMATED UPDATE OF TIME BASED SELECTION

(71) Applicant: Uwe Schwerk, Heidelberg (DE)

(72) Inventor: Uwe Schwerk, Heidelberg (DE)

(73) Assignee: SAP AG, Walldorf (DE)

(21) Appl. No.: 13/534,762

(22) Filed: Jun. 27, 2012

(51) Int. Cl. G06F 9/44

(52) U.S. Cl. 718/100

(57) ABSTRACT

A computer implemented method for setting time based selections in an application may include obtaining saved settings relating to a first time setting and setting second time settings based on the saved settings. The saved settings may include a first time setting and a time stamp corresponding to the first time setting. Setting the second time settings based on the saved settings may include using a relation between the time stamp and the first time settings to set the second time settings. Setting the second time settings based on the saved settings may include determining the relation of the time stamp to the first time setting and setting the second time setting such that the relation exists between the current time and the second time setting.

### BACKGROUND

Analytical reports can generate data based on settings defining parameters for the report. Such settings may include time based selections for the report. The time based selections can define the date and/or time parameters for the report. For example, a time based selection may include a specific calendar day or calendar week, a certain interval defined by start and end date, specific days of a week or specific hours of a day. The analytical report can be generated using the time based selections. Typically analytical reports are used recurrently (e.g. every week). To prevent the user from reentering all selections again, the previous selections can be stored for later reuse.

Some applications may include the previously entered selections in a new analysis. Typically, the selections which need to be adapted are the time based selections due to passage of time. A user may manually update the time based selections.

To provide an automatic method to set the time based selections that may not need to be updated, some applications include predetermined variables that are associated with the time based selections. For example, a variable may represent the last thirty days or the current year to date. Thus, a user may be provided with options to perform the analysis with time based selections that correspond to the available variables. However, in such applications, specific coding must be included for each of the variables and the available options may be limited.

### BRIEF DESCRIPTION OF THE DRAWINGS

The accompanying drawings illustrate the present invention and, together with the description, further serve to explain the principles of the invention and to enable one skilled in the pertinent art to make and use the invention.

FIG. 1 illustrates a method for controlling time based selections.

FIG. 2 illustrates a method for receiving and setting time settings.

FIGS. 3-5 illustrate an example of automatically updating time setting based on a previous time setting.

FIG. 6 illustrates an exemplary architecture of a computing device.

### DETAILED DESCRIPTION

Embodiments of the present invention provide systems, apparatuses and methods to automatically set or update one or more time based selections. The embodiments provide for new time based selection to be determined based on previously set time based selections. The embodiments may also be used to automatically update outdated time based selection in a relative way.

A computer implemented method for setting time based selections in an application may include obtaining saved settings relating to a first time setting and setting second time settings based on the saved settings. The saved settings may include a first time setting and a time stamp corresponding to the first time setting. Setting the second time settings based on the saved settings may include using a relation between the time stamp and the first time settings to set the second time settings.

In one embodiment, setting the second time settings based on the saved settings may include determining the relation of the time stamp to the first time setting and setting the second time setting such that the relation exists between the current time and the second time setting.

In another embodiment, setting the second time settings based on the saved settings may include shifting each value in the first time setting by a value corresponding to a difference between the time stamp and a current time.

A computer system for setting time based selections in an application may include a data storage device storing data including a first time setting and a time stamp corresponding to the first time setting and a processor in communication with the data storage device. The processor may be configured to obtain the saved settings stored in the data storage device and to set a second time setting based on the saved settings. The second time setting may be set based on a relation between the time stamp and the first time setting.

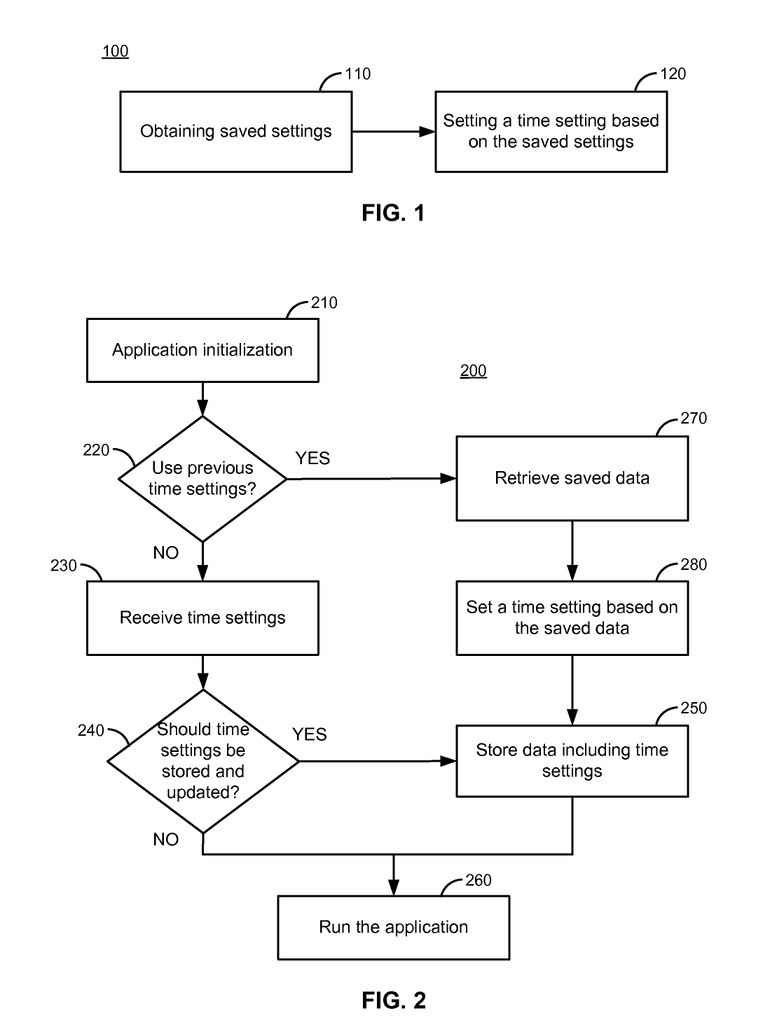

FIG. 1 illustrates a method 100 for controlling time based selections. The method 100 may be performed by a computer having one or more processors. The method 100 may be performed when providing time settings for an application performing operations based on one or more settings, such as processing an analytical report or generating data, but is not so limited. The method 100 may include obtaining saved settings in step 110 and setting a time setting based on the saved setting in step 120.

In step 110, the saved settings may correspond to data relating to time based selections and may include one or more of a time stamp corresponding to a time when previous time based selections were made and the previous time setting. The time based selections may include one or more time settings. The saved settings may be included in a file (e.g., metadata of a file) relating to a previous analytical report or in a file containing the previous settings. The saved settings may be saved in a storage device on a computer or an external storage device associated with a device executing the application. The saved settings may also be time based selections currently entered in a user interface of an application.

The time stamp may correspond to a time when the previous time settings of the report were entered, when the previous time setting was saved, when an analysis was started using the setting or when the report was completed using the setting. The time stamp correspond to a time and/or date and may include one or more of the year, month, day, hour, minute, and second. The time stamp may be a time of the system on which the application is generated or a time at a predetermined location, such as a location of a central server or a location of the headquarters.

The previous time settings may include one or more settings entered by a user for a previous execution of the application. The previous time setting may include settings that were saved by a user. The previous time settings may also include settings automatically generated or updated with a previous execution of the application. The time settings may include time settings from another application that are introduced into the application needing time based selections to be made.

The time settings may include the date and/or time that define processing parameters for the application. The time settings may include the calendar day, week, month, quarter or year. The time settings may include the hour, minute or second. The time settings may include specific instances of one or more days and/or times, a range of the dates and/or times, or a combination thereof. The time settings may include accounting periods like fiscal quarters or fiscal years. The time settings may also include a time period that is before or after a certain data, or a time period between that excludes certain time periods (e.g., specific days or weeks).

In step 120, setting a time setting may be performed based on the setting obtained in step 110. The setting of the time setting may be made automatically. The setting may be made at the time the application is loaded or opened. The setting may also be made when a request is made to update the time settings.

In step 120, setting the time setting may be performed based on the saved settings including at least one of a time stamp and a previous time setting. In this step, a calculation can be performed to determine a relation between the previously set time settings and the time stamp associated with the previously set time settings. The relation can be calculated after the previously used time settings and the time stamp are obtained. Alternatively, the relation can be calculated at the time the previous settings are saved with the time stamp. The relation between the previously set time settings and the time stamp can be saved together with the previously set time settings and the time stamp.

Thus, setting the time setting may include calculating a relation of the time stamp to the previous time settings and applying the calculated relation to the current time. Such a calculation may be applied when a time dimension (e.g., hour, calendar day, week, month, quarter, or year) is used in the time settings. For example, if the previous setting includes a last full week, a calculation can be made to determine that the relation to the time stamp is the last full week. This relation can be applied to the current date to set the time setting.

The relation may include a difference between the time stamp and the current time. The difference may be saved as a reference value. The reference value may be used to set the new settings by adding the reference value to the previous time setting. For example, if the difference between the time stamp and the current date is ten days, ten days may be added to the previous time settings and included in the time settings of the application.

FIG. 2 illustrates a method for receiving and setting time settings. The method may include application initialization in step 210, determining whether to use previous time settings in step 220, receiving time settings in step 230, determining whether settings should be stored and whether the settings should be updated in step 240, storing data including time settings and current time stamp in step 250, running the application in step 260, retrieving saved data in step 270 and setting a time setting based on the saved data in step 280.

Application initialization in step 210 may include opening the application or starting an operation in the application. A determination may be made as to whether previous time settings should be used to run the current instance of the application in step 220. The determination may include determining whether previous settings are saved in a predefined location or whether settings are made to use previous time settings. The settings to use previous time settings may be made at the time the program is opened, before the analysis or reporting is started, at the time previous settings were saved, at the time previous settings were entered, at the time the previous settings were used by the application, or at the time the previous application provided results based on the previous settings.

If it is determined that the previous time settings should not be used to run the current instance of the application in step 220, then the time settings can be received in step 230. The time settings can be received from a user entering the time settings. The time settings may also be received from another application or data storage location.

In step 240, a determination can be made as to whether the settings that are received in step 230, should be stored and whether the settings should be updated on subsequent executions of the application. For example, when a decision is made to store the settings a decision may also be made to update the time based selections of the settings. Thus, if the user decides to store the settings, he may additionally make a selection to update the time selection automatically on subsequent executions of the application with these stored settings. The determination in step 240 may also be made after the application is initialized in step 210 or before the time settings are received in step 230.

If it is determined in step 240 that the time settings should be stored, then data can be saved relating to the settings in step 250. If it is determined in step 240 that the time settings should be updated, then an update time based selection upon load flag can also be set when the data is stored in step 250. The data that is saved in step 250 may include data relating the time based selections and may include one or more of the time settings and a time stamp, but is not so limited. If it is determined in step 240 that the time settings should not be stored and updated, then the application can be executed in step 260 based on the time settings received in step 230, without saving the time settings in step 250.

If in step 220 it is determined that the previous time settings should be used to run the current instance of the application, then saved data can be retrieved in step 270. The saved data can be retrieved from a storage device associated with a computer executing the application or from an external storage device. The saved data may also be retrieved from fields into which the time based settings are made in the application. The saved data may include time based settings and may include one or more of the previous time settings and a time stamp. The time stamp may be associated with the previous time settings.

The saved data can be used in step 280 to set the settings. The settings can be set based on a relation of the previous time setting to the time stamp or based on a difference between the time stamp and current time.

The time settings that are set in step 280 can be saved in step 250. The saved data may include one or more of the time settings and a time stamp. Storing the data in step 250 may replace the previously saved data (e.g., the time stamp and time settings can be updated). After the settings have been made in step 280 and the data optionally saved in step 250, the application can be executed in step 260 based on the set time setting.

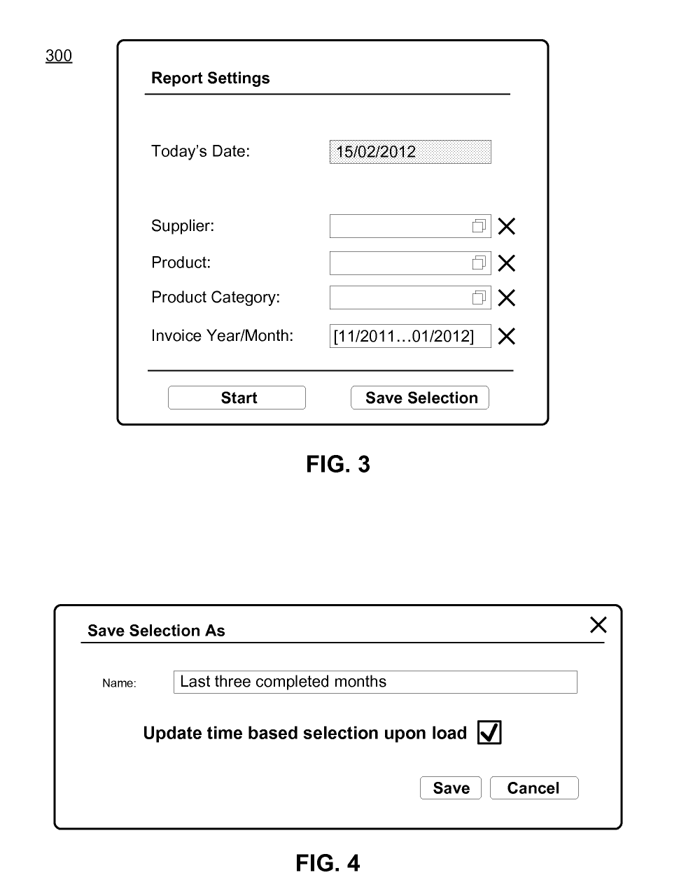

FIGS. 3-5 illustrate an example of automatically updating time based selections using previous time based selections. As shown in FIG. 3, a time based selection may be set on Feb. 15, 2012. The time based selection includes setting the range for the invoice year and month. In FIG. 3, using a current date of Feb. 15, 2012, the three previous completed months are selected (i.e., November 2011 to January 2012). Using the time based selection, the application may be executed. An option may also be provided to save the time based selection.

Once the execution is started or when the option to save the time based selection is made, an option may be provided for the user to save the selection of the time based selection. Example of such an option is shown in FIG. 4. As shown in FIG. 4, the user may save the selection with an option to “update time based selection upon load.” With such option selected, the time based selection will be updated automatically when the saved data is loaded based on the current time and on the relation of the time based selection to the time stamp when the saved data is loaded.

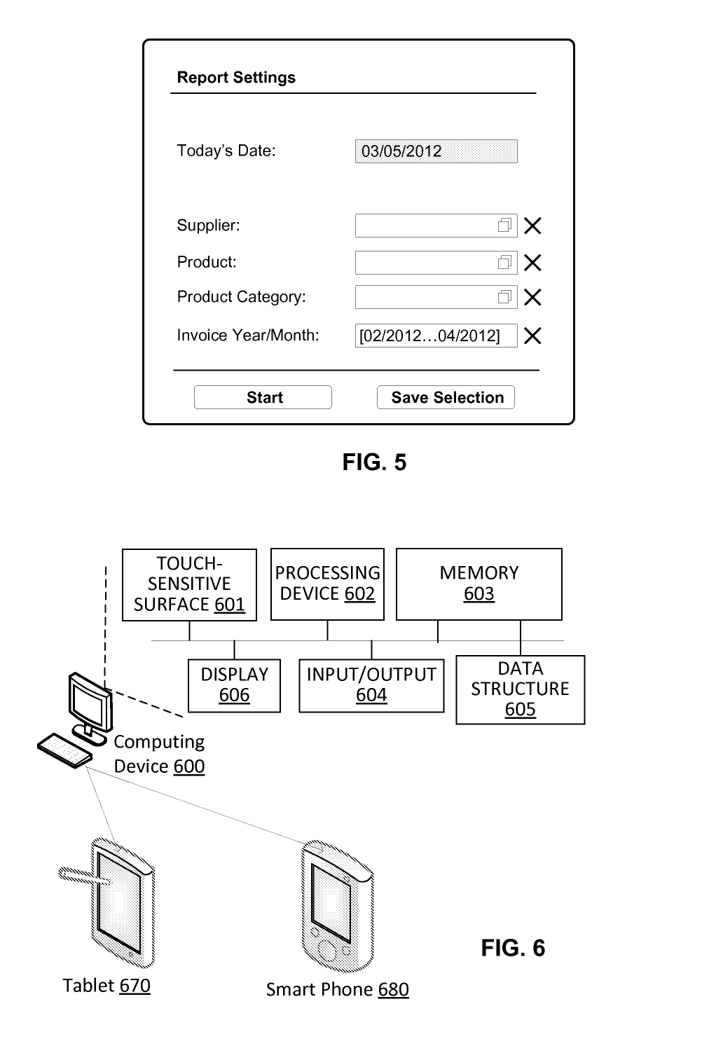

FIG. 5 illustrates an example of loading time based settings based on the relation between the time stamp and the time based selection shown in FIG. 3. The relation between the time stamp in FIG. 3 and the three previous months can be applied to the current date of May 3, 2012 shown in FIG. 5. Thus, February 2012 to April 2012 can be automatically selected in the time based selection. The settings shown in FIG. 5 can be used to save a new file with the current time stamp and the current time based selection. Alternative, the current time stamp and the current time based selection can be used to update the data in the file used make the time based setting.

FIG. 6 illustrates an exemplary architecture of a computing device 600. A computing device 600 may include a touch-sensitive surface 601, a processing device 602, a memory 603 storing structured data 605, an input/output device 604, and a display 606. Each of these components 601 to 606 may be interconnected via a system bus.

In some instances, a surface of the display 606 may be the touch-sensitive surface 601, though in other instances the two may be separate. Additionally, in some instances the computing device 600 may be a tablet 670, smart phone 680, or other type of portable computing device, though the computing device 600 need not be portable.

Communications input/output device 604 may enable connectivity between the computing device 600 and other computing systems, peripherals, and devices by encoding and/or transmitting data to be sent to the external devices and receiving and/or decoding data received from the external devices.

In an embodiment, memory 603 may contain different components for retrieving, presenting, changing, and saving data. Memory 603 may include a variety of memory devices, for example, Dynamic Random Access Memory (DRAM), Static RAM (SRAM), flash memory, cache memory, and other memory devices.

Processing device 602 may perform computation and control functions of a system and comprises a suitable central processing unit (CPU). Processing device 602 may include a single integrated circuit, such as a microprocessing device, or may include any suitable number of integrated circuit devices and/or circuit boards working in cooperation to accomplish the functions of a processing device. Processing device 602 may execute computer programs, such as object-oriented computer programs, within memory 603.

The computing device 600 may be used to execute the application to perform the analytical analysis or generate data based on the time based selection. The selection of the time based selection may be entered via the touch sensitive surface 601 or via the devices coupled to the input/output device 604. The time stamp and the time based selections can be saved in the memory 603 or an external data storage (not shown). The application may be executed using the processing device 602. The application may also be executed on a computer coupled to the computing device 600 via a network. The network may include a LAN, WAN, bus, or the Internet. The external storage device may also be coupled to the computing device 600 via the network.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software or hardware, but some systems and methods consistent with the present invention may be implemented in both software and hardware.

We claim:

1. A computer implemented method for setting time based selections in an application, comprising:
obtaining saved settings including a first time setting and a time stamp corresponding to the first time setting; and
setting a second time setting, different from the first time setting, based on the saved settings, wherein a relation between the time stamp and the first time setting is used to set the second time setting.

2. The method of claim 1, wherein setting the second time setting based on the saved settings includes determining the relation of the time stamp to the first time setting and setting the second time setting such that the relation exists between the current time and the second time setting.

3. The method of claim 1, wherein setting the second time setting based on the saved settings includes shifting each value in the first time setting by a value corresponding to a difference between the time stamp and a current time.

4. The method of claim 1, further comprising providing a user with an option to save entered time settings as the first time setting.

5. The method of claim 1, wherein the time stamp corresponds to a time when the first time setting was entered.

6. The method of claim 1, wherein the time stamp corresponds to a time when the first time setting was used by the application.

7. The method of claim 1, wherein the time stamp corresponds to a time when the first time setting was saved by the user.

8. The method of claim 1, wherein the first time setting is a setting previously used by the application.

9. The method of claim 1, wherein the time setting includes at least one of a year, a month, a day, an hour and a minute, intervals and combinations thereof.

10. The method of claim 1, further comprising saving the current time and the second time setting.

11. The method of claim 1, further comprising saving the current time as the time stamp and saving the second time setting in place of the first time setting.

12. A non-transitory computer readable medium comprising a set of saved instructions that, when executed by a processing device, cause the processing device to:
obtain saved settings including a first time setting and a time stamp corresponding to the first time setting; and
set a second time setting, different from the first time setting, based on the saved settings, wherein a relation between the time stamp and the first time setting is used to set the second time setting.

13. A computer system for setting time based selections in an application comprising:
a data storage device storing data including a first time setting and a time stamp corresponding to the first time setting;
a processor in communication with the data storage device, the processor being configured to:
obtain the saved settings stored in the data storage device; and
set a second time setting, different from the first time setting, based on the saved settings, wherein a relation between the time stamp and the first time setting is used to set the second time setting.

14. The computer system of claim 13, wherein setting the second time setting based on the saved settings includes shifting each value in the first time setting by a value corresponding to the difference between the time stamp and a current time.

15. The computer system of claim 13, wherein setting the second time setting based on the saved settings includes determining the relation of the time stamp to the first time setting and setting the second time setting such that the relation exists between the current time and the second time setting.

16. The method of claim 13, wherein the processor is further configured to provide a user with an option to save entered time settings as the first time setting.

17. The computer system of claim 13, wherein the time stamp corresponds to a time when the first time setting was entered.

18. The computer system of claim 13, wherein the time stamp corresponds to a time when the first time setting was used by the application.

19. The computer system of claim 13, wherein the time stamp corresponds to a time when the first time setting was saved.
